(19) United States
(12) Patent Application Publication
(10) Pub. No.: US 2023/0376921 A1
(43) Pub. Date: Nov. 23, 2023

(54) INFORMATION PROCESSING APPARATUS, VEHICLE, AND NON-TRANSITORY STORAGE MEDIA

(71) Applicant: TOYOTA JIDOSHA KABUSHIKI KAISHA, Toyota-shi Aichi-ken (JP)

(72) Inventors: Daiki KUBO, Toshima-ku Tokyo-to (JP); Natsumi KOIKE, Shinagawa-ku Tokyo-to (JP); Toshifumi NISHIJIMA, Kasugai-shi Aichi-ken (JP); Hiroki AWANO, Nerima-ku Tokyo-to (JP)

(73) Assignee: TOYOTA JIDOSHA KABUSHIKI KAISHA, Toyota-shi Aichi-ken (JP)

(21) Appl. No.: 18/197,289

(22) Filed: May 15, 2023

(30) Foreign Application Priority Data
May 17, 2022 (JP) 2022-080623

(51) Int. Cl. G06Q 20/14; G01C 21/34; B60W 40/08

(52) U.S. Cl. CPC G06Q 20/14; G01C 21/3438; B60W 40/08; B60W 2040/0881; B60W 2540/01

(57) ABSTRACT

The in-vehicle display includes a first display for a driver of a vehicle and a second display for a fellow passenger of the vehicle. An information processing apparatus does not display payment code on the in-vehicle display while the vehicle is in operation when no fellow passenger is present in the vehicle. The information processing apparatus displays the payment code on the second display while the vehicle is in operation when a fellow passenger is present in the vehicle.

### CROSS REFERENCE TO THE RELATED APPLICATION

This application claims the benefit of Japanese Patent Application No. 2022-080623, filed on May 17, 2022, which is hereby incorporated by reference herein in its entirety.

### BACKGROUND

### Technical Field

Present disclosure relates to technology for controlling display of an in-vehicle display.

### Description of the Related Art

Patent document 1 discloses technology for a wallet system that includes a vehicle. In the wallet system disclosed in Patent Literature 1, the wallet server, a payment provider server, a user terminal, and a vehicle can communicate with each other via a network. In addition, Patent Literature 1 describes a payment method in which payment is made when a bar code or QR code (registered trademark) displayed on the vehicle is read by a user terminal.

### CITATION LIST

### Patent Literature

Patent Literature 1: Japanese Patent Application Laid-Open Publication No. 2021-157576

### SUMMARY

An object of the present disclosure is to make the payment code more appropriately displayed on an in-vehicle display.

An information processing apparatus according to the first aspect of the present disclosure is an information processing apparatus comprising a controller that controls the display of an in-vehicle display, the in-vehicle display including a first display for a driver of the vehicle and a second display for a fellow passenger of the vehicle, wherein when no fellow passenger is present in the vehicle, the controller does not display payment code on the in-vehicle display while the vehicle is in operation, and wherein when a fellow passenger is present in the vehicle, the controller displays the payment code on the second display while the vehicle is in operation.

The vehicle according to the second aspect of the present disclosure is comprised with the information processing apparatus according to the first aspect of the present disclosure.

The non-transitory storage medium according to the third aspect of the present disclosure stores a program, wherein the program causes a computer to execute an information processing method for controlling a display of an in-vehicle display, the in-vehicle display includes a first display for a driver of the vehicle and a second display for a fellow passenger of the vehicle, and the information processing method includes, when no fellow passenger is present in the vehicle, not displaying the payment code on the in-vehicle display while the vehicle is in operation, and when a fellow passenger is present in the vehicle, displaying the payment code on the second display while the vehicle is in operation.

According to this disclosure, the payment code can be more appropriately displayed on the in-vehicle display.

### BRIEF DESCRIPTION OF THE DRAWINGS

FIG. 1 indicates the schematic structure of a payment system according to an embodiment.

FIG. 2 is a block diagram to explain a hardware configuration of an in-vehicle device and various devices installed in a vehicle.

FIG. 3 indicates an arrangement of first display and second display in interior of a vehicle.

FIG. 4 is a block diagram indicating an example of a functional configuration of an in-vehicle device.

FIG. 5 is a flowchart indicating a flow of display process according to a first embodiment.

FIG. 6 indicates an arrangement of the first display and multiple second displays in interior of the vehicle.

FIG. 7 is a flowchart indicating a flow of display process for a second embodiment.

### DESCRIPTION OF THE EMBODIMENTS

The information processing apparatus for the first aspect of this disclosure controls the display of an in-vehicle display. The in-vehicle display includes a first display and a second display. The first display is for the driver of a vehicle. The second display is for fellow passenger of the vehicle. The first display may be located near the driver's seat in an interior of the vehicle. The second display may be located near a seat other than the driver's seat in the interior of the vehicle. The first and second displays do not necessarily need to be separate. In other words, in a single display located in front of the driver's seat and the front passenger's seat in the interior of the vehicle and between the two seats, the driver's side portion may be the first display and the front passenger's side portion may be the second display.

In the information processing apparatus of the present disclosure, the controller controls the display of the payment code on the in-vehicle display. Here, the payment code is a code used for payment when a user, who is the driver or fellow passenger in the vehicle, orders a predetermined product or service. The user reads the payment code displayed on the in-vehicle display with a user terminal owned by the user, thereby performing payment processing. This allows the user to complete payment for the ordered products or services while in the vehicle.

The controller then controls the display of the payment code on the in-vehicle display based on whether or not a fellow passenger is present while the vehicle is in operation. Specifically, when no fellow passenger is present in the vehicle, the controller does not display the payment code on the in-vehicle display while the vehicle is in operation. On the other hand, when a fellow passenger is present in the vehicle, the controller displays the payment code on the second display while the vehicle is in operation.

While the vehicle is in operation, it is difficult for the driver to read the payment code displayed on the in-vehicle display with the user terminal. Therefore, in the present disclosure, when no fellow passenger is present while the vehicle is in operation, the payment code is not displayed on the in-vehicle display. In this case, the controller may then display the payment code on the first display after the operation of the vehicle stops. Displaying the payment code on the first display among the first and second displays included in the in-vehicle display makes it easier for the driver to read the payment code by the user terminal.

In the present disclosure, when a fellow passenger is present in the vehicle, the payment code is displayed on the second display of the first and second displays included in the in-vehicle display while the vehicle is in operation. This makes it easier for the fellow passenger to read the payment code with the user terminal.

Thus, according to this disclosure, the payment code can be displayed on the appropriate in-vehicle display at the appropriate time. As a result, the convenience for users to make payments in vehicles can be improved.

Specific embodiments of the present disclosure will be described below on the basis of the drawings. The technical scope of the present disclosure is not limited to sizes, materials, shapes, relative arrangement, and the like of constituent components described in the present embodiments unless otherwise described.

### First Embodiment

(System Overview)

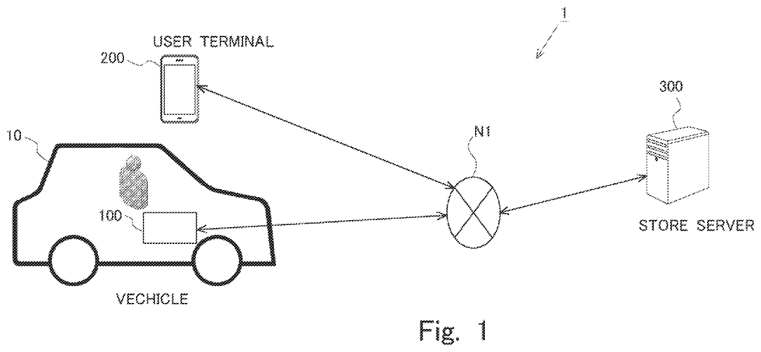

FIG. 1 indicates the schematic structure of the payment system. This embodiment of payment system is used for payment of fees by users. The user executes payment of charges when ordering a given product or service from a given store while riding in the vehicle 10. Here, the user in vehicle 10 is a driver or a fellow passenger of vehicle 10.

The payment system 1 includes an in-vehicle device 100, a user terminal 200, and a store server 300. The in-vehicle device 100 is a device mounted on the vehicle 10 and includes a computer. The user terminal 200 is a terminal held by the user in the vehicle 10. The store server 300 is a server that manages orders for products or services to a given store.

In the payment system 1, the in-vehicle device 100 and the user terminal 200 are connected to the store server 300 via a network N1. The network N1 may be, for example, a WAN (Wide Area Network), which may be a global public communication network such as the Internet, or a telephone communication network, such as cellular phone communication network.

The in-vehicle device 100 accepts orders for predetermined products or services from users in the vehicle 10. The in-vehicle device 100 then transmits the information on the order for the predetermined product or service received from the user (hereinafter referred to as “order information”) to the store server 300 via the network N1. When the order information is received from the in-vehicle device 100, the store server 300 transmits information (hereinafter, referred to as “code information”) related to a payment code for payment of a charge for the ordered predetermined commodity or service to the in-vehicle device 100 via the network N1. The code information includes information about the payee of the fee. The code information may also include information regarding the amount of the fee.

When the in-vehicle device 100 receives the code information from the store server 300, it displays the payment code on the vehicle 10 displays the payment code on the in-vehicle display. Bar codes or QR codes are examples of payment codes displayed on in-vehicle displays. User terminal 200 is equipped with a camera capable of reading payment codes. In addition, the user terminal 200 executes a predetermined application to realize payment by reading a payment code. A smartphone, tablet computer, mobile computer, or wearable computer can be exemplified as a user terminal 200. In the vehicle 10, the user reads the payment code displayed on the in-vehicle display by the user terminal 200, and the payment process for payment of the fee for the predetermined products or services is performed.

(Hardware Configuration)

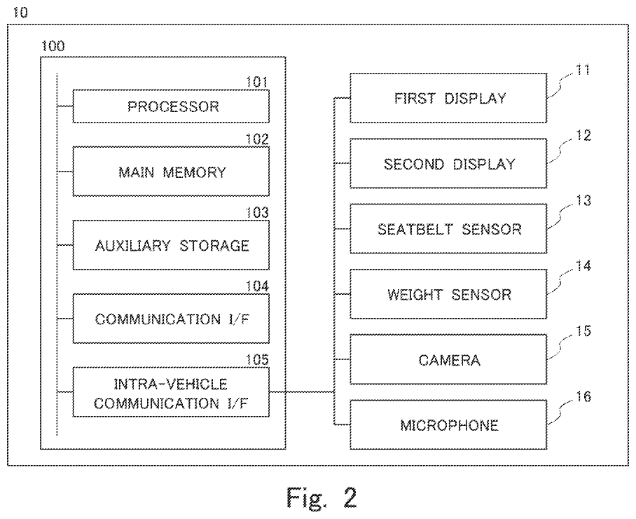

FIG. 2 is a block diagram illustrating the hardware configuration of the in-vehicle device 100 and the various devices in the vehicle 10. The in-vehicle device 100 includes a processor 101, main memory 102, auxiliary storage 103, communication interface (communication I/F) 104, and an intra-vehicle communication interface (intra-vehicle communication I/F) 105.

Here, processor 101 is, for example, a CPU (Central Processing Unit) or DSP (Digital Signal Processor). The main memory 102 is, for example, RAM (Random Access Memory). The auxiliary storage 103 is, for example, ROM (Read Only Memory), HDD (Hard Disk Drive), or flash memory. Auxiliary storage 103 may also include removable media (portable recording media). Examples of the removable medium include a USB memory, an SD card, and disc recording media, such as a CD-ROM, a DVD, and a Blu-ray disc.

The communication I/F 104 is an interface for connecting the in-vehicle device 100 to the network N1. The communication I/F 104, for example, uses a prescribed wireless communication standard such as 3G (3rd Generation) or LTE (Long Term Evolution) or other prescribed wireless communication standards to connect the in-vehicle device 100 to the network N1. The communication I/F 104 is, for example, a LAN (Local Area Network) interface board or a wireless communication circuit for wireless communication.

The In-vehicle communication I/F 105 is an interface for the in-vehicle device 100 is an interface for the in-vehicle device to communicate with other devices in the vehicle 10 using a specified in-vehicle communication standard. Examples of the predetermined in-vehicle communication standard include CAN (Controller Area Network) and LIN (Local Interconnect Network).

In the in-vehicle device 100 with the above configuration, an operating system (OS), various types of programs, and various types of information tables are stored in the auxiliary storage 103. The processor 101 loads the program stored in the auxiliary storage unit 103 into the main memory 102 and executes the program, thereby realizing a display process for displaying the payment code on the in-vehicle display, as described below. However, some or all of the functions in the in-vehicle device 100 may be realized by hardware circuits such as ASICs and hardware circuits such as ASICs and FPGAs. The in-vehicle device 100 is not necessarily constructed as a single physical entity, but it may be constructed by a plurality of cooperating computers. In this embodiment, the in-vehicle device 100 corresponds to the “information processing apparatus” of the first aspect of the present disclosure.

The vehicle 10 also has a first display 11, a second display 12, seatbelt sensors 13, weight sensors 14, a camera 15, and a microphone 16 and various other devices. The in-vehicle device 100 communicates with these devices by the In-vehicle communication I/F 105.

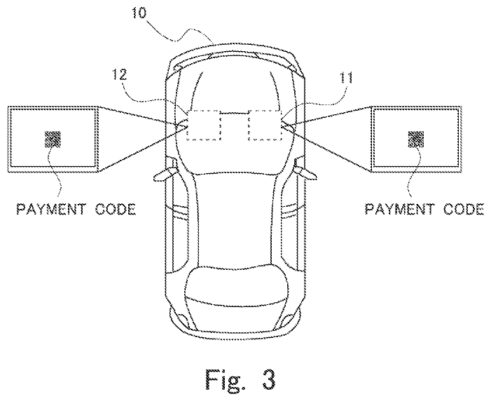

The first display 11 and the second display 12 are in-vehicle displays installed in interior of the vehicle. The first display 11 is a display for the driver, and the second display 12 is a display for the fellow passenger. FIG. 3 indicates the arrangement of the first display 11 and second display 12 displays in interior of the vehicle. Here, vehicle 10 is a right-hand drive vehicle. The first display 11 is installed at a position corresponding to the driver's seat in interior of the vehicle. The second display 12 is installed at a position corresponding to the passenger seat in interior of the vehicle. Both the first display 11 and the second display 12 are configured to display payment codes.

The first display 11 and second display 12 may consist of a single display. In this case, one display is installed in front of the driver's seat and the front passenger seat in interior of the vehicle, between the two seats. Then, in one display, the driver's side part functions as the first display 11 and the passenger side part functions as the second display 12 functions as the second display.

The seatbelt sensors 13 and the weight sensors 14 are installed in each seat of the vehicle 10. The seatbelt sensor 13 detects whether or not a seat belt is worn in each seat of the vehicle 10. The weight sensor 14 detects the magnitude of the load on each seat of the vehicle 10. The camera 15 is located in interior of the vehicle. The camera 15 captures images interior of the vehicle. The microphone 16 is located in interior of the vehicle. The microphone 16 captures the user's sound in interior of the vehicle.

(Functional Configuration)

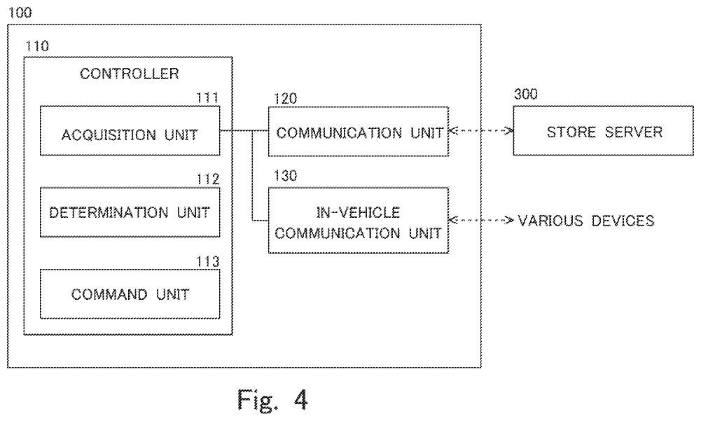

Next, the functional configuration of the in-vehicle device 100 is explained based on FIG. 4 FIG. 4 is a block diagram indicating an example of the functional configuration of the in-vehicle device 100. The in-vehicle device 100 has a controller 110, a communication unit 120 and an in-vehicle communication unit 130. The controller 110 has the function of performing arithmetic operations to control the in-vehicle device 100. The controller 110 can be realized by the processor 101.

The communication unit 120 has the function of connecting the in-vehicle device 100 to the network N1. The communication unit 120 includes a communication I/F104. The communication unit 120 can communicate with the store server 300 via network N1. The in-vehicle communication unit 130 has the function of communicating with various devices in the vehicle 10. The in-vehicle communication unit 130 includes an In-vehicle communication I/F 105.

Here, the user in the vehicle 10 can order a given product or service by voice. Specifically, the sound uttered by the user to order a given product or service is captured by microphone 16. Then, in the in-vehicle device 100, the controller 110 executes the process of receiving the sound information collected by the microphone 16 using the in-vehicle communication unit 130. In addition, controller 110 generates order information based on the received sound information. The controller 110 then executes the process of transmitting the generated order information to the store server 300 using the communication unit 120.

The in-vehicle device 100 may also accept orders for predetermined goods or services from the user via the first display 11 or the second display 12. In this case, the first display 11 and second display 12 have touch panel functions to accept input operations by the user. The controller 110 then generates the order information based on the information entered by the user on the first display 11 or the second display 12 to generate order information based on the information entered by the user.

In the in-vehicle device 100, the controller 110 includes, as functional parts to realize the display process of payment codes, an acquisition unit 111, a determination unit 112, and a command unit 113. As described above, when the store server 300 receives order information from the in-vehicle device 100, it sends the in-vehicle device 100, it transmits the code information to the in-vehicle device 100. Then, in the in-vehicle device 100, the controller 110 executes a process of receiving the code information transmitted from the store server 300 using the communication unit 120.

Here, when the order information is transmitted from the in-vehicle device 100 to the store server 300 during the driving of the vehicle 10, the in-vehicle device 100 receives the code information from the store server 300 during the driving of the vehicle 10. When the code information is received in the in-vehicle device 100 while the vehicle 10 is in operation, the controller 110 executes a process to determine whether or not a fellow passenger is present in the vehicle 10.

Specifically, in the controller 110, the acquisition unit 111 acquires the detection values of the seatbelt sensor 13 installed in each seat. Furthermore, the determination unit 112 determines whether or not a fellow passenger is present in the vehicle 10 based on the acquired detection values of each seatbelt sensor 13. At this time, if a seat belt of a seat other than the driver's seat is worn in the vehicle 10, the determination unit 112 determines that a fellow passenger is present in the vehicle 10. Then, the control unit 110 controls the display of the payment code on the first display 11 or the second display 12 based on the determination result by the determination unit 112.

Specifically, if it is determined that there are no fellow passengers in the vehicle 10, the controller 110 does not display the payment code on either the first display 11 and the second display 12 do not display the payment code. On the other hand, if it is determined that a fellow passenger is present in the vehicle 10, the controller 110 displays the second display 12 to display the payment code. In this case, the command unit 113 sends a command to the second display 12 to display the payment code including the code information received from the store server 300 to display a payment code including the code information received from the store server 30.

<Display Process Flow>

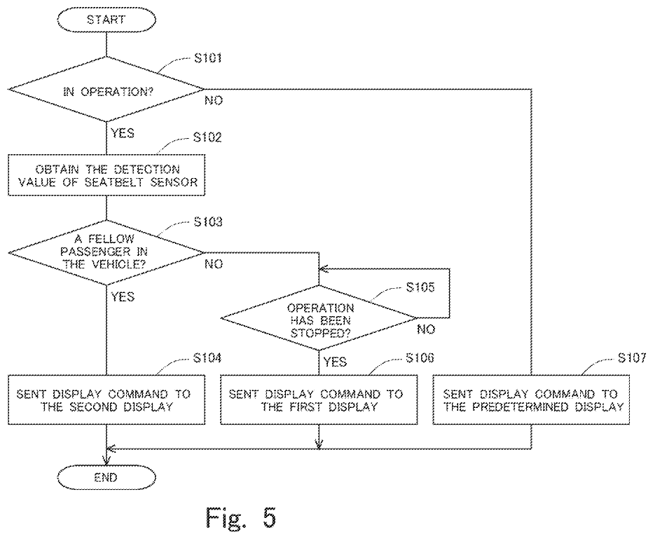

Hereinafter, a flow of display processing according to the present embodiment will be described with reference to FIG. 5. FIG. 5 is a flowchart indicating the flow of the display process. When the in-vehicle device 100 receives the code information from the store server 300, the controller 110 executes this flow.

In this flow, first, at S101, it is determined whether or not the vehicle 10 is in operation. IF a negative determination is made in the S101, that is, if the operation of the vehicle 10 is at a standstill, a process of the S107 is executed next. In S107, a command is sent to the predetermined display of the first display 11 and the second display 12, a command is sent to the predetermined display to display the payment code. The predetermined display may be either one of the first display 11 or the second display 12, or both. This causes the payment code to appear on the predetermined display. The execution of this flow is then terminated.

On the other hand, if a positive judgment is made in S101, that is, if the vehicle 10 is in operation, then the S102 is executed next. In S102, the detection value of each seatbelt sensor 13 is obtained. Next, in S103, whether or not a fellow passenger is present in the vehicle 10 is determined based on the detected values of each seatbelt sensor 13.

If a positive decision is made in S103, that is, if there is a fellow passenger in the vehicle 10, then the S104 is executed next. In S104, a command is sent to the second display 12 to display the payment code S104. This causes the settlement payment code to be displayed on the second display 12. The execution of this flow is then terminated.

On the other hand, if a negative judgment is made in S103, that is, if there are no fellow passengers in the vehicle 10, then in S105, it is determined whether or not the operation of the vehicle 10 has been stopped. If S105 is denied, the process of S105 is executed again. In other words, while the vehicle 10 is in operation, neither the first display 11 nor the second display 12, no payment codes are displayed on either display 11 or display 22. On the other hand, if a positive judgment is made in S105, the process in S106 is executed next. In S106, a command is sent to the first display 11 to display the payment code S106. This causes the payment code to be displayed on the first display 11 after the vehicle 10 has been out of operation. The execution of this flow is then terminated.

(Action/Effect)

When no fellow passenger is present in the vehicle 10, the user, the driver, must read the payment code with the user terminal 200. However, it is difficult for the driver to read the payment code displayed on the in-vehicle display with the user terminal 200 while the vehicle 10 is in operation. Therefore, in the display process according to the present embodiment, as described above, when the vehicle 10 is in operation and there are when no fellow passenger is present, neither the first display 11 nor the payment code is not displayed on either of the second displays 12. The payment code is then displayed on the first display 11 after the vehicle 10 has stopped driving. Accordingly, the payment code can be displayed on the first display 11 in a state where the driver of the vehicle 10 can safely perform the reading work of the payment code by the user terminal 200. In addition, by displaying the payment code on the first display 11 which is an in-vehicle display for the driver, it becomes easier for the driver to read the payment code by the user terminal 200.

Even while the vehicle 10 is in operation, the fellow passenger can perform the task of reading the payment code displayed on the in-vehicle display with the user terminal 200. The passenger can read the payment code displayed on the in-vehicle display using the user terminal 200. Therefore, in the display process according to the present embodiment, as described above, when a fellow passenger is present while the vehicle 10 is in operation, the payment code is displayed on the second display 12. This allows the payment code to be displayed on the second display 12 as soon as possible. In addition, by displaying the payment code on the second display 12 for the fellow passenger, the fellow passenger can easily read the payment code with the user terminal 200.

As mentioned above, the display process for this embodiment of system allows the payment code to be displayed on the appropriate in-vehicle display at the appropriate time. As a result, the convenience for users to make payments in the vehicle 10 can be improved.

### Modification

In this embodiment, the controller 110 of the in-vehicle device 100 is used to determine whether the vehicle 10 based on a detection value of the seatbelt sensor installed in each seat to determine whether or not a fellow passenger is present in the vehicle 10. However, other methods may be used to determine if fellow passengers are present in the vehicle 10.

For example, the controller 110 may determine whether or not there is a fellow passenger in the vehicle 10 based on the detection value of the weight sensor 14 provided in each seat of the vehicle 10. In this case, if a load of a predetermined weight or more is applied to a seat other than the driver's seat in the vehicle 10, the determination unit 112 determines that a fellow passenger is present in the vehicle 10. The controller 110 may also determine whether or not a fellow passenger is present based on the in-interior image captured by the camera 15. The controller 110 may also determine whether or not a fellow passenger is present based on the sound collected by the microphone 16. Further, the controller 110 may determine whether or not a fellow passenger is present by combining at least one of the detection values of the seatbelt sensors 13, the detection values of the weight sensors 14, the in-vehicle image captured by the camera 15, and the sound collected by the microphone 16.

### Second Embodiment

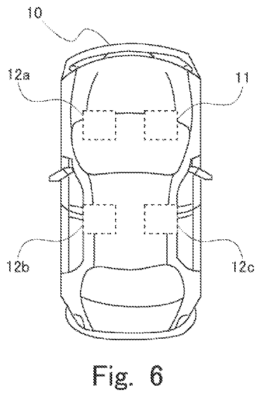

In the present embodiment, a plurality of second displays 12 are provided in interior of the vehicle 10. FIG. 6 indicates the arrangement of the first display 11 and a plurality of second displays 12 in interior of the vehicle. In the following, when each of the multiple second displays 12 is described separately, the reference number of each second display, 12a, 12b, and 12c as reference numbers for each second display.

As indicated in FIG. 6, in the present embodiment, the first display 11 is also installed at a position corresponding to the driver's seat in interior of the vehicle. The second display 12a is installed at a position corresponding to the passenger seat in interior of the vehicle. The second display 12b is installed at a position corresponding to the rear seat on the left side (behind the passenger seat) in interior of the vehicle. The second display 12c is installed at a position corresponding to the rear seat on the right side (behind the driver's seat) in interior of the vehicle. The first display 11 and each of the second displays 12a, 12b, and 12c are all configured to display payment codes.

And in the present embodiment, when the in-vehicle device 100 receives the code information from the store server 300 receives the code information from the vehicle 10, it is determined whether or not a fellow passenger is present in the vehicle 10. Furthermore, in the present embodiment, when a fellow passenger is present in the vehicle 10, the first seat, which is the seat in which the fellow passenger is seated, is identified. That is, the passenger seat, the left rear seat, and the right rear seat are identified as the first seat. Then, of the plurality of second displays 12a, 12b, 12c, only the second display 12 corresponding to the first seat displays a payment code.

### <Display Process Flow>

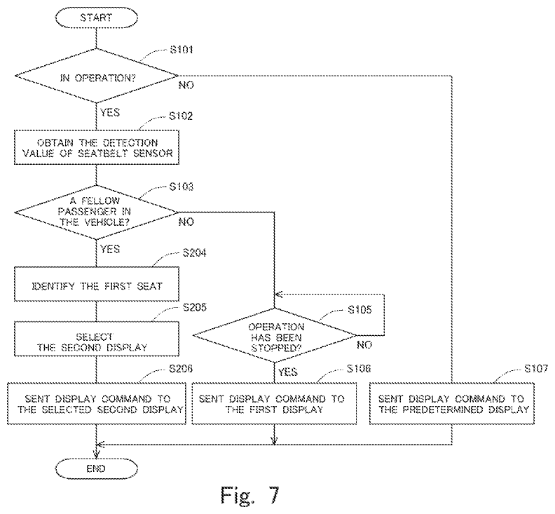

Hereinafter, a flow of display processing according to the present embodiment will be described with reference to FIG. 7 FIG. 7 is a flowchart illustrating a flow of display processing according to the present embodiment. When the in-vehicle device 100 receives the code information from the store server 300, the controller 110 executes this flow. In this flow, instead of processing S104 in the flow indicated in FIG. 5, S204, S205, and S206 are executed instead of S104 in the flow shown in FIG. 5. The processing performed in each step in this flow other than S204, S205, and S206 in this flow are the same as those in the steps with the same reference numbers in the flow indicated in FIG. 5

In this flow, if a positive judgment is made in S103, that is, if a fellow passenger is present in the vehicle 10, then the S204 processing is executed. In S204, the first seat on which the fellow passenger is seated is identified. In this S204, the first seat is identified based on a detection value of each seatbelt sensor 13 obtained in S102. In other words, the seat to which the seat belt is attached is identified as the first seat.

Next, in S205, the second display 12 corresponding to the first seat is selected from among the plurality of second displays 12a, 12b, and 12c. Next, in the S206, a command to display the payment code is transmitted to the second display 12 selected in the S205. This causes the payment code to be displayed on the second display 12 corresponding to the first seat. The execution of this flow is then terminated.

In the display process according to the present embodiment, when a fellow passenger is present, the payment code is displayed on the second display 12 corresponding to the first seat on which the fellow passenger is seated while the vehicle is in operation. Accordingly, in a case where a plurality of second displays 12 are provided in the interior of the vehicle 10, the fellow passenger can more easily perform the work of reading the payment code by the user terminal 200.

### Modification

In the present embodiment, the controller 110 of the in-vehicle device 100 identifies the first seat based on the detection value of the seatbelt sensor 13 provided in each seat of the vehicle 10. However, the first seat may be identified in other ways.

For example, the control unit 110 may specify the first seat based on the detection value of the weight sensor 14 provided in each seat of the vehicle 10. The controller 110 may also identify the first seat based on the in-interior image captured by the camera 15. The controller 110 may also identify the first seat based on the sound collected by the microphone 16. Further, the controller 110 may identify the first seat by combining at least one of the detection value of each seatbelt sensor 13, the detection value of each weight sensor 14, the in-vehicle image captured by the camera 15, and the sound collected by the microphone 16.

Even when multiple second displays 12 are provided in interior of the vehicle 10, a specific second display 12 for displaying the payment code may be set in advance. For example, if it is assumed that the user executing the payment processing using the user terminal 200 will often be seated in the passenger seat of the vehicle 10, the second display 12a corresponding to the passenger seat may be set in advance as the specific second display 12 on which the payment code is displayed.

The in-vehicle device 100 may also be used to receive a predetermined product or service from a user via one of the plurality of second displays 12. In this case, the payment code may be displayed on the second display 12 where the user performed the input operation to place the order.

### Other Embodiments

The embodiments described above are merely examples, and the present disclosure may be changed and implemented as appropriate within the scope of the disclosure. Furthermore, processes and structure described in the present disclosure may be freely combined to the extent that no technical conflict exists.

Furthermore, a process that is described to be performed by one apparatus may be shared and performed by a plurality of apparatuses. Processes described to be performed by different apparatuses may be performed by one apparatus. Which function is to be implemented by which hardware configuration (server configuration) in a computer system may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), and any type of medium suitable for storing electronic instructions, such as read-only memories (ROMs), random access memories (RAMS), EPROMs, EEPROMs, magnetic cards, flash memories, or optical cards.

What is claimed is:

1. An information processing apparatus comprising a controller that controls display of an in-vehicle display, the in-vehicle display including a first display for a driver of the vehicle and a second display for a fellow passenger of the vehicle, wherein
when no fellow passenger is present in the vehicle, the controller does not display payment code on the in-vehicle display while the vehicle is in operation, and when a fellow passenger is present in the vehicle, the controller displays the payment code on the second display while the vehicle is in operation.

2. The information processing apparatus according to claim 1, wherein
when no fellow passenger is present in the vehicle, the controller displays the payment code on the first display after the operation of the vehicle stops.

3. The information processing apparatus according to claim 1, wherein
the in-vehicle display includes a plurality of second displays, and
when a fellow passenger is present in the vehicle, the controller displays the payment code only on a specific second display among the plurality of second displays.

4. The information processing apparatus according to claim 3, wherein
the controller identifies a first seat on which a fellow passenger is seated in an interior of the vehicle, and selects a second display corresponding to the first seat as the specific second display among the plurality of second displays.

5. The information processing apparatus according to claim 1, wherein
the controller determines whether or not a fellow passenger is present in the vehicle based on a detection value of a seatbelt sensor installed in each seat of the vehicle.

6. The information processing apparatus according to claim 1, wherein
the controller determines whether or not a fellow passenger is present in the vehicle based on a detection value of a weight sensor installed in each seat of the vehicle.

7. The information processing apparatus according to claim 1, wherein
the controller determines whether or not a fellow passenger is present in the vehicle based on an interior image captured by a camera installed in an interior of the vehicle.

8. The information processing apparatus according to claim 1, wherein
the controller determines whether or not a fellow passenger is present based on sound collected by a microphone installed in an interior of the vehicle.

9. The information processing apparatus according to claim 4, wherein
the controller identifies the first seat based on a detection value of a seatbelt sensor installed in each seat of the vehicle.

10. The information processing apparatus as claimed in claim 4, wherein
the controller identifies the first seat based on the detection value of the weight sensor installed in each seat of the vehicle.

11. The information processing apparatus according to claim 4, wherein
the controller identifies the first seat based on an interior image of the vehicle captured by a camera installed in the interior of the vehicle.

12. The information processing apparatus according to claim 4, wherein
the controller identifies the first seat based on sound collected by a microphone installed in the interior of the vehicle.

13. A vehicle equipped with an information processing apparatus according to claim 1.

14. A non-transitory storage medium storing a program, wherein
the program causes a computer to execute an information processing method for controlling display of an in-vehicle display,
the in-vehicle display includes a first display for a driver of the vehicle and a second display for a fellow passenger of the vehicle, and
the information processing method includes, when no fellow passenger is present in the vehicle, not displaying the payment code on the in-vehicle display while the vehicle is in operation, and when a fellow passenger is present in the vehicle, displaying the payment code on the second display while the vehicle is in operation.

15. The non-transitory storage medium according to claim 14, wherein
the information processing method includes, when no fellow passenger is present in the vehicle, displaying the payment code on the first display after the operation of the vehicle stops.

16. The non-transitory storage medium according to claim 14, wherein
the in-vehicle display includes a plurality of second displays, and
the information processing method includes, when a fellow passenger is present in the vehicle, displaying the payment code only on a specific second display among the plurality of second displays.

17. The non-transitory storage medium according to claim 16, wherein
the information processing method further includes
identifying a first seat on which a fellow passenger is seated in an interior of the vehicle; and
selecting a second display corresponding to the first seat as the specific second display among the plurality of second displays.

18. The non-transitory storage medium according to claim 14, wherein
in the information processing method, whether or not a fellow passenger is present in the vehicle is determined based on a detection value of a seatbelt sensor installed in each seat of the vehicle.

19. The non-transitory storage medium according to claim 14, wherein
in the information processing method, whether or not a fellow passenger is present in the vehicle is determined based on a detection value of a weight sensor installed in each seat of the vehicle.

20. The non-transitory storage medium according to claim 14, wherein
in the information processing method, whether or not a fellow passenger is present in interior of the vehicle is determined based on an interior image captured by a camera installed in the interior of the vehicle.
